(19) United States
(12) Patent Application Publication
(10) Pub. No.: US 2006/0088022 A1
(43) Pub. Date: Apr. 27, 2006

(54) Wireless transfer system

(75) Inventor: Itaru Hogyoku, Kashihara-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/257,037

(22) Filed: Oct. 25, 2005

(30) Foreign Application Priority Data
Oct. 25, 2004 (JP) 2004-309097

(51) Int. Cl. H04J 3/24

(52) U.S. Cl. 370/349

(57) ABSTRACT

According to the invention, a wireless transfer system including a wireless transfer transmitter that converts a source signal fed thereto into a radiowave and transmits the radiowave and a wireless transfer receiver that receives the radiowave transmitted from the wireless transfer transmitter and converts the radiowave back into the original source signal to produce an external output signal further has a timer circuit, a memory, and a control circuit that creates, by using the timer circuit, information relating to a wireless connection duration between the wireless transfer transmitter and the wireless transfer receiver and stores the created information in the memory. This configuration alleviates limitations on where to enjoy chargeable contents and permits collection of viewing fees through a simple procedure.

This nonprovisional application claims priority under 35 U.S.C. § 119(a) on Patent Application No. 2004-309097 filed in Japan on Oct. 25, 2004, the entire contents of which are hereby incorporated by reference.

### BACKGROUND OF THE INVENTION

1. Field of the Invention

The present invention relates to a wireless transfer system that includes a wireless transfer transmitter and a wireless transfer receiver and that permits a source signal such as an audiovisual signal fed to the wireless transfer transmitter to be transferred from the wireless transfer transmitter to the wireless transfer receiver by wireless communication so as to be outputted to an external device connected to the wireless transfer receiver.

2. Description of Related Art

In recent years, research and development have been done on broadcasting technologies, such as terrestrial radiowave digital broadcast, that permit transmission of dramatically larger volumes of contents than ever. This has been offering increasingly wide choices in all aspects to both users and broadcast companies. Now that a huge number of channels are available, broadcast companies can more easily seek for business opportunities through the broadcasting of chargeable contents.

To receive such chargeable contents, a user (viewer) needs to buy or rent a set for receiving chargeable contents (for example, see Japanese Patent Application Laid-open No. 2003-244672) from a broadcast company or the like.

A set for receiving chargeable contents is configured, for example, like the broadcast reception STB (set-top box) 1 shown in FIG. 19. The broadcast reception STB 1 is provided with an input terminal 21, a broadcast reception/demodulation circuit 22, an output terminal 23, and a broadcast reception/demodulation control circuit 24. The input terminal 21 is connected, on a wired basis, to a broadcast reception antenna (unillustrated) or a CATV (cable television) cable (unillustrated). The output terminal 23 is connected, on a wired basis, to a television monitor 2.

The broadcast reception/demodulation control circuit 24 gives the broadcast reception/demodulation circuit 22 instructions to select a reception frequency, start reception of a broadcast, stop reception of a broadcast, and perform other operations. According to instructions from the broadcast reception/demodulation control circuit 24, the broadcast reception/demodulation circuit 22 selects, from among signals fed in via the input terminal 21, the video and audio signals belonging to the intended reception channel. The broadcast reception/demodulation circuit 22 then demodulates the selected video and audio signals, and then outputs the demodulated signals to the output terminal 23. Based on the signals outputted via the output terminal 23, the television monitor 2 reproduces pictures and sounds.

There are no particular restrictions on the modulation scheme by which the signals fed from the broadcast reception antenna or CATV cable to the input terminal 21 of the broadcast reception STB 1 are modulated. Here, as a mere example, the video and audio signals outputted via the output terminal 23 are assumed to be analog signals adapted for the NTSC system.

When a viewer receives chargeable contents with the system configuration shown in FIG. 19, unless the viewer extends the cable connecting between the broadcast reception STB 1 and the television monitor 2, the viewer can enjoy chargeable contents only around the broadcast reception STB 1. Inconveniently, such limitations on the part of viewers have been preventing a rapid, significant growth in audience despite the availability of an increased number of channels and hence wider choices of chargeable contents.

On the other hand, if viewers are obliged to go through a complicated procedure to pay viewing fees, they will be less willing to buy chargeable contents.

### SUMMARY OF THE INVENTION

An object of the present invention is to provide a wireless transfer system that alleviates limitations on where to enjoy chargeable contents and that permits collection of viewing fees through a simple procedure, and to provide a fee billing system and a viewing control system employing such a wireless transfer system.

To achieve the above object, according to one aspect of the present invention, a wireless transfer system including a wireless transfer transmitter that converts a source signal fed thereto into a radiowave and transmits the radiowave and a wireless transfer receiver that receives the radiowave transmitted from the wireless transfer transmitter and converts the radiowave back into the original source signal to produce an external output signal is further provided with a time counting portion, a storage portion, and a control portion that creates, by using the time counting portion, information relating to a wireless connection period between the wireless transfer transmitter and the wireless transfer receiver and stores the created information in the storage portion.

With this configuration, the device (for example, a broadcast reception STB) that feeds the source signal to the wireless transfer transmitter and the device (for example, a television monitor) that is fed with the external output signal outputted from the wireless transfer receiver can be installed at sites remote from each other. This helps reduce limitations on where to enjoy chargeable contents. Moreover, the wireless connection period between the wireless transfer transmitter and the wireless transfer receiver is stored in the storage portion. Based on this information, it is possible to bill viewing fees through a simple procedure (for example, in proportion to the amount of information acquired).

The wireless transfer system configured as described above may be further provided with a broadcast receiver that produces the source signal from a broadcast signal fed thereto and outputs the source signal to the wireless transfer transmitter. In this case, the broadcast receiver and the wireless transfer transmitter are housed in one housing.

With this configuration, it is possible to save the trouble of connecting the broadcast receiver and the wireless transfer transmitter together on a wired basis.

The wireless transfer system configured as described above may be further provided with an external interface for delivering to an external device the information relating to the wireless connection period between the wireless transfer transmitter and the wireless transfer receiver as stored in the storage portion.

With this configuration (hereinafter the first configuration), it is easy to retrieve information relating to the wireless connection period between the wireless transfer transmitter and the wireless transfer receiver, and thus it is possible to bill viewing fees through a simpler procedure.

To achieve the above object, according to anther aspect of the present invention, a fee billing system is provided with the wireless transfer system of the first configuration described above, and a fee biller that calculates the amount of money to be billed according to the information from the external interface provided in the wireless transfer system.

To achieve the above object, according to anther aspect of the present invention, a wireless transfer system including a wireless transfer transmitter that converts a source signal fed thereto into a radiowave and transmits the radiowave and a wireless transfer receiver that receives the radiowave transmitted from the wireless transfer transmitter and converts the radiowave back into the original source signal to produce an external output signal is further provided with a time counting portion, an external interface for receiving information relating to a permitted viewing period from outside, and a control portion that controls, by using the time counting portion and according to the information relating to the permitted viewing period, whether or not to permit wireless connection between the wireless transfer transmitter and the wireless transfer receiver.

With this configuration (hereinafter the second configuration), the device (for example, a broadcast reception STB) that feeds the source signal to the wireless transfer transmitter and the device (for example, a television monitor) that is fed with the external output signal outputted from the wireless transfer receiver can be installed at sites remote from each other. This helps reduce limitations on where to enjoy chargeable contents. Moreover, whether or not to permit wireless connection between the wireless transfer transmitter and the wireless transfer receiver is controlled according to the information relating to the permitted viewing period. Thus, based on this information relating to the permitted viewing period, it is possible to bill viewing fees through a simple procedure (for example, on a pre-payment basis).

To achieve the above object, according to anther aspect of the present invention, a wireless transfer system including a wireless transfer transmitter that converts a source signal fed thereto into a radiowave and transmits the radiowave and a wireless transfer receiver that receives the radiowave transmitted from the wireless transfer transmitter and converts the radiowave back into the original source signal to produce an external output signal is further provided with a broadcast receiver that produces the source signal from a broadcast signal fed thereto and outputs the source signal to the wireless transfer transmitter, a time counting portion, an external interface for receiving information relating to a permitted viewing period from outside, and a control portion that controls, by using the time counting portion and according to the information relating to the permitted viewing period, whether or not to permit the broadcast receiver to receive a broadcast. Here, the broadcast receiver and the wireless transfer transmitter are housed in one housing.

With this configuration (hereinafter the third configuration), the same benefits as those obtained with the second configuration described above can be obtained. In addition, it is possible to save the trouble of connecting the broadcast receiver and the wireless transfer transmitter together on a wired basis.

To achieve the above object, according to another aspect of the present invention, a viewing control system is provided with the wireless transfer system of the second or third embodiment described above and an information transmitter that sends the information relating to the permitted viewing period to the external interface provided in the wireless transfer system.

To achieve the above object, according to another aspect of the present invention, a wireless transfer system including a wireless transfer transmitter that converts a source signal fed thereto into a radiowave and transmits the radiowave and a wireless transfer receiver that receives the radiowave transmitted from the wireless transfer transmitter and converts the radiowave back into the original source signal to produce an external output signal is further provided with a time counting portion, an external interface for receiving electronic money data from outside, and a control portion that converts the electronic money data into information relating to a permitted viewing period and controls, by using the time counting portion and according to the information relating to the permitted viewing period, whether or not to permit wireless connection between the wireless transfer transmitter and the wireless transfer receiver.

With this configuration (hereinafter the fourth configuration), the device (for example, a broadcast reception STB) that feeds the source signal to the wireless transfer transmitter and the device (for example, a television monitor) that is fed with the external output signal outputted from the wireless transfer receiver can be installed at sites remote from each other. This helps reduce limitations on where to enjoy chargeable contents. Moreover, the electronic money data is converted into the information relating to the permitted viewing period, and whether or not to permit wireless connection between the wireless transfer transmitter and the wireless transfer receiver is controlled according to the information relating to the permitted viewing period. Thus, based on the electronic money data, it is possible to bill viewing fees through a simple procedure (for example, on a pre-payment basis).

To achieve the above object, according to another aspect of the present invention, a wireless transfer system including a wireless transfer transmitter that converts a source signal fed thereto into a radiowave and transmits the radiowave and a wireless transfer receiver that receives the radiowave transmitted from the wireless transfer transmitter and converts the radiowave back into the original source signal to produce an external output signal is further provided with a broadcast receiver that produces the source signal from a broadcast signal fed thereto and outputs the source signal to the wireless transfer transmitter, a time counting portion, an external interface for receiving electronic money data from outside, and a control portion that converts the electronic money data into information relating to a permitted viewing period and controls, by using the time counting portion and according to the information relating to the permitted viewing period, whether or not to permit the broadcast receiver to receive a broadcast. Here, the broadcast receiver and the wireless transfer transmitter are housed in one housing.

With this configuration (hereinafter the fifth configuration), the same benefits as those obtained with the fourth configuration described above can be obtained. In addition, it is possible to save the trouble of connecting the broadcast receiver and the wireless transfer transmitter together on a wired basis.

To achieve the above object, according to another aspect of the present invention, a viewing control system is provided with the wireless transfer system of the fourth or fifth embodiment described above and an information transmitter that sends the electronic money data to the external interface provided in the wireless transfer system.

According to the present invention, it is possible to realize a wireless transfer system that alleviates limitations on where to enjoy chargeable contents and that permits collection of viewing fees through a simple procedure, and to realize a fee billing system and a viewing control system employing such a wireless transfer system. Moreover, according to the present invention, it is possible to provide a system that permits chargeable contents to be enjoyed on up to as many television monitors as there are in a household. This helps motivate more viewers to buy chargeable contents, and thus helps offer wider choices to both broadcast companies and viewers.

### BRIEF DESCRIPTION OF THE DRAWINGS

FIG. 1 is a diagram showing the configuration of the wireless transfer system of a first embodiment of the invention;

FIG. 2 is a diagram showing the wireless connection sequence performed in the wireless transfer system shown in FIG. 1;

FIG. 3 is a diagram showing the configuration of the wireless transfer system of a second embodiment of the invention;

FIG. 4 is a diagram showing the configuration of the wireless transfer system of a third embodiment of the invention;

FIG. 5 is a diagram showing the connection relationship between the wireless transfer system of the third embodiment of the invention and a fee biller;

FIG. 6 is a diagram showing a modified example of the wireless transfer system of the third embodiment of the invention;

FIG. 7 is a diagram showing a modified example of the wireless transfer system of the third embodiment of the invention;

FIG. 8 is a diagram showing a modified example of the wireless transfer system of the third embodiment of the invention;

FIG. 9 is a diagram showing a modified example of the wireless transfer system of the third embodiment of the invention;

FIG. 10 is a diagram showing the configuration of the wireless transfer system of a fourth embodiment of the invention;

FIG. 11 is a flow chart showing an example of the procedure performed to control wireless connection in the wireless transfer system of the fourth embodiment of the invention;

FIG. 12 is a flow chart showing another example of the procedure performed to control wireless connection in the wireless transfer system of the fourth embodiment of the invention;

FIG. 13 is a diagram showing a modified example of the wireless transfer system of the fourth embodiment of the invention;

FIG. 14 is a diagram showing the configuration of the wireless transfer system of a fifth embodiment of the invention;

FIG. 15 is a flow chart showing an example of the procedure performed to control wireless connection in the wireless transfer system of the fifth embodiment of the invention;

FIG. 16 is a flow chart showing another example of the procedure performed to control wireless connection in the wireless transfer system of the fifth embodiment of the invention;

FIG. 17 is a diagram showing the configuration of the wireless transfer system of a sixth embodiment of the invention;

FIG. 18 is a diagram showing the configuration of the wireless transfer system of a seventh embodiment of the invention; and

FIG. 19 is a diagram showing the configuration of a broadcast reception STB as an example of a conventional set for receiving chargeable contents.

### DETAILED DESCRIPTION OF PREFERRED EMBODIMENTS

### First Embodiment

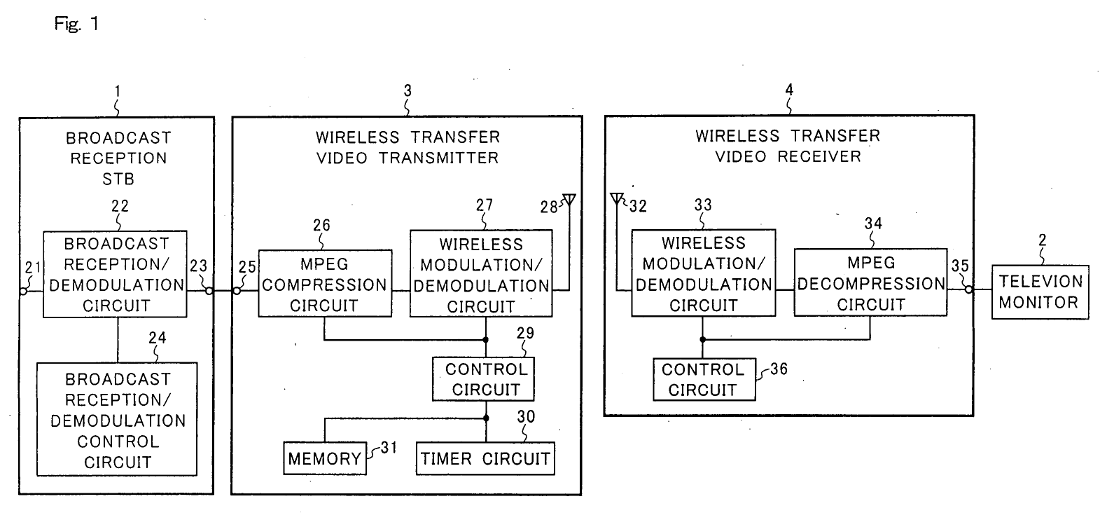

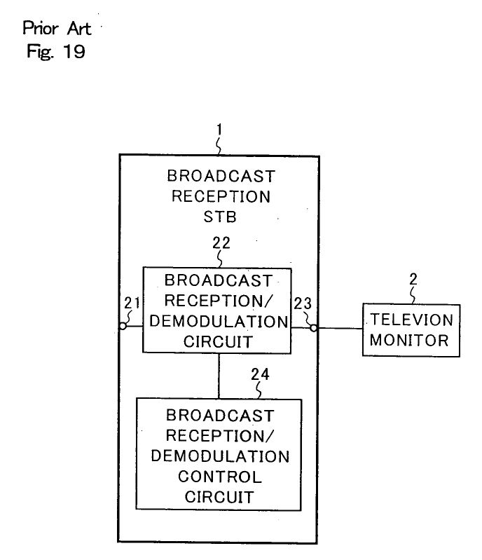

FIG. 1 shows the configuration of the wireless transfer system of a first embodiment of the present invention. In FIG. 1, such parts as are found also in FIG. 19 are identified with a reference numerals, and no detailed explanations thereof will be repeated.

The wireless transfer system of the first embodiment of the invention includes a wireless transfer video transmitter 3 and a wireless transfer video receiver 4. The output terminal 23 of the broadcast reception STB 1 is connected, on a wired basis, not to the television monitor 2 but to an input terminal 25 of the wireless transfer video transmitter 3. The television monitor 2 is connected to an output terminal 35 of the wireless transfer video receiver 4. The wireless transfer video transmitter 3 modulates the video and audio signals outputted from the broadcast reception STB 1, and then transmits them wirelessly to the wireless transfer video receiver 4. The wireless transfer video receiver 4 demodulates the wirelessly received signals back into the original video and audio signals, and then feeds them to the television monitor 2.

In this way, using the wireless transfer system of the first embodiment makes it possible to install the television monitor 2 at a site remote from where the broadcast reception STB 1 is installed. This alleviates limitations on where to enjoy chargeable contents.

Now, the configuration and operation of the wireless transfer system of the first embodiment of the invention will be described in detail.

The wireless transfer video transmitter 3 is provided with an input terminal 25, an MPEG compression circuit 26, a wireless modulation/demodulation circuit 27, an antenna 28, a control circuit 29, a timer circuit 30, and a memory 31. The control circuit 29 controls the MPEG compression circuit 26, the wireless modulation/demodulation circuit 27, the timer circuit 30, and the memory 31.

The MPEG compression circuit 26 checks for input of video and audio signals (in this embodiment, analog signals adapted for the NTSC system) via the input terminal 25. If the MPEG compression circuit 26 recognizes input of video and audio signals via the input terminal 25, it converts them into digital data, then compresses the digital data with an MPEG algorithm, and the outputs the compressed digital data.

The wireless modulation/demodulation circuit 27 modulates the compressed digital data from the MPEG compression circuit 26 with a signal in a predetermined frequency band (for example, in the 2.4 GHz or 5.2 GHz band), and then feeds the modulated signal to the antenna 28. Moreover, the wireless modulation/demodulation circuit 27 exchanges control data for maintaining wireless communication between the wireless transfer video transmitter 3 and the wireless transfer video receiver 4 with the wireless modulation/demodulation circuit 33 via the antennas 28 and 32, and feeds received control data to the control circuit 29.

The control circuit 29 gives the MPEG compression circuit 26 instructions to perform various operations such as analog-to-digital conversion of the video and audio signals, starting and stopping of data compression, and changing of the data compression rate. Moreover, the control circuit 29 gives the wireless modulation/demodulation circuit 27 instructions to perform various operations such as selection of a wireless channel to be used, starting and stopping of wireless communication, and also instructs the wireless modulation/demodulation circuit 27 to exchange data, with respect to wireless communication with the wireless transfer video receiver 4, for starting and stopping of wireless communication, selection of a wireless channel to be used, and setting of the MPEG compression rate.

The wireless transfer video receiver 4 is provided with an antenna 32, a wireless modulation/demodulation circuit 33, an MPEG decompression circuit 34, an output terminal 35, and a control circuit 36. The control circuit 36 controls the wireless modulation/demodulation circuit 33 and the MPEG decompression circuit 34.

The wireless modulation/demodulation circuit 33 demodulates the signal in the predetermined frequency band (for example, in the 2.4 GHz or 5.2 GHz band) transmitted from the wireless transfer video transmitter 3 and received via the antenna 32 to retrieve the original compressed digital data, and then outputs the compressed digital data. Moreover, the wireless modulation/demodulation circuit 33 exchanges control data for maintaining wireless communication between the wireless transfer video transmitter 3 and the wireless transfer video receiver 4 with the wireless modulation/demodulation circuit 27 via the antennas 32 and 28, and feeds received control data to the control circuit 36.

In the wireless transfer system of the first embodiment of the invention, digital data is transferred wirelessly. Thus, in comparison with when analog data is transferred wirelessly, it is possible to reduce deterioration of signals (for example deterioration of signals resulting from interference with another wireless station or under the influence of a reflected radiowaves). Moreover, in the wireless transfer system of the first embodiment of the invention, data compression is performed with an MPEG algorithm to reduce the amount of data that needs to be transferred wirelessly. This helps lower the cost of the wireless modulation/demodulation circuit and hence the price of the wireless transfer system.

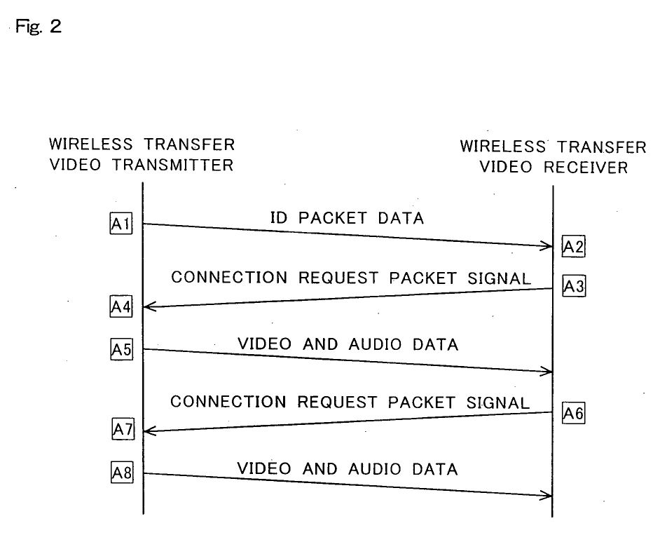

Next, the wireless connection sequence between the wireless transfer video transmitter 3 and the wireless transfer video receiver 4 will be described with reference to FIG. 2.

When started-up, the wireless transfer video transmitter 3 transmits ID packet data including an ID that identifies this particular wireless transfer video transmitter (step A1). At this point, the wireless transfer video transmitter 3 does not know even whether its partner wireless transfer video receiver 4 is located within a wirelessly communicable range, and thus does not know whether the partner wireless transfer video receiver 4 can receive the ID packet data, and therefore transmits the ID packet data periodically (for example, at every 100 milliseconds).

When started-up, the wireless transfer video receiver 4 tries to receive the ID packet data transmitted from the wireless transfer video transmitter 3, and searches for it until it actually receives it. When the wireless transfer video receiver 4 succeeds in receiving the ID packet data, it checks whether or not the received ID is that of the connection partner (step A2). This check is made in one of the following or other ways. According to one way, the wireless transfer video transmitter 3 and the wireless transfer video receiver 4 are assigned the same ID beforehand so that communication takes place between products assigned the same ID. According to another, in the wireless transfer video receiver 4, the ID of a would-be partner wireless transfer video transmitter 3 is stored so that the ID of the wireless transfer video transmitter 3 can be confirmed as that of the connection partner by the wireless transfer video receiver 4. In this embodiment, the wireless transfer video transmitter 3 and the wireless transfer video receiver 4 are assumed to be assigned the same ID to permit the confirmation of the ID of the wireless transfer video transmitter 3.

When the wireless transfer video receiver 4 confirms that the received ID packet data is that from the wireless transfer video transmitter 3 assigned the ID of the connection partner, the wireless transfer video receiver 4 transmits a connection request packet signal to the wireless transfer video transmitter 3 (step A3). Here, the connection request packet signal incorporates the ID of the wireless transfer video transmitter to permit the wireless transfer video transmitter 3 to confirm it. This is to prevent, in a case where there are installed more than one pair of a transmitter and a receiver, the wireless transfer video transmitter 3 from receiving a connection request packet signal from another wireless transfer video receiver. In this way, to permit recognition of which wireless transfer video transmitter is being requested for connection, every connection request packet signal is incorporated in the ID of the target wireless transfer video transmitter. For the same purpose, the ID of a wireless transfer video receiver may be used instead, provided that the partner wireless transfer video transmitter can confirm it.

Through the sequence described above, the wireless transfer video transmitter 3 transmits ID packet data, and meanwhile waits for a connection request packet signal from the wireless transfer video receiver 4.

On receiving the connection request packet signal, the wireless transfer video transmitter 3 checks whether or not it is from the connection partner (step A4). Specifically, since the wireless transfer video receiver 4 incorporates the ID of the wireless transfer video transmitter in the connection request packet signal as described above, the wireless transfer video transmitter 3 checks whether or not its own ID is incorporated in the connection request packet signal. If the wireless transfer video transmitter 3 recognizes that its own ID is not incorporated in the connection request packet signal, the connection request packet signal is recognized as not being one transmitted from the connection partner wireless transfer video receiver. Thus, the wireless transfer video transmitter 3 discards this connection request packet signal, and continues to transmit ID packet data.

By contrast, if the wireless transfer video transmitter 3 recognizes that its own ID is incorporated in the connection request packet signal, the connection request packet signal is recognized as one that the connection partner has sent back after reading the ID of the wireless transfer video transmitter 3. Thus, the wireless transfer video transmitter 3 confirms that its partner wireless transfer video receiver is located in a wirelessly communicable range and is receiving the ID packet data transmitted from the wireless transfer video transmitter 3. On completion of this confirmation, the wireless transfer video transmitter 3 modulates the video and audio data from the MPEG compression circuit 26 and transmits it. (step A5). Here, the video and audio data incorporates the ID of the wireless transfer video transmitter so that the wireless transfer video receiver does not mistake it for video and audio data from another wireless transfer video transmitter.

The wireless transfer video receiver 4 converts the received and then demodulated video and audio data into analog signals with the MPEG decompression circuit 34, and then outputs them to the television monitor 2. To inform the wireless transfer video transmitter 3 that the video and audio data therefrom is reaching the wireless transfer video receiver 4, the wireless transfer video receiver 4, while receiving the video and audio data, simultaneously transmits a connection request packet signal periodically (for example, at every second) (step A6).

On the other hand, the wireless transfer video transmitter 3, by confirming that it is periodically receiving the connection request packet signal from the wireless transfer video receiver 4, can recognize that the wireless transfer video receiver 4 is operating and is receiving video and audio data (step A7).

By contrast, if the wireless transfer video receiver 4 cannot receive video and audio data, it should not transmit a connection request packet signal. While the wireless transfer video transmitter 3 is supposed to receive a connection request packet signal at every second, if it cannot receive one for 10 seconds or more on end, the wireless transfer video receiver 4 may be turned off, or may be moved to where wireless communication is impossible. In either case, the wireless transfer video transmitter 3 stops transmitting video and audio data (step A8), and switches to the transmission of ID packet data (step A1).

Next, with reference back to FIG. 1, the timer circuit 30 and the memory 31 provided in the wireless transfer video transmitter 3 will be described. When the control circuit 29 recognizes that, on one hand, the MPEG compression circuit 26 is not detecting “null signals” as the video and audio signals fed in via the input terminal 25 and simultaneously that, on the other hand, the wireless modulation/demodulation circuit 27 is engaged in wireless connection with the wireless transfer video receiver 4, the control circuit 29 detects the time at that moment with the timer circuit 30, and stores the detected time as the viewing start time in the memory 31. Thereafter, when the control circuit 29 recognizes either that the MPEG compression circuit 26 has detected “null signals” as the video and audio signals fed in via the input terminal 25 or that the wireless modulation/demodulation circuit 27 has severed wireless connection with the wireless transfer video receiver 4, the control circuit 29 detects the time at that moment with the timer circuit 30, and stores the detected time as the viewing end time in the memory 31.

In this way, the viewing start time and the viewing end time are accurately stored in the memory 31. Thus, based on the times stored in the memory 31, viewing fees can be billed through a simple procedure.

The control circuit 29 may subtract the viewing start time from the viewing end time to calculate the viewing duration and then store the viewing start time and the viewing duration in the memory 31, instead of storing the viewing start time and the viewing end time in the memory 31. Also in this case, based on the time and duration stored in the memory 31, viewing fees can be billed through a simple procedure.

### Second Embodiment

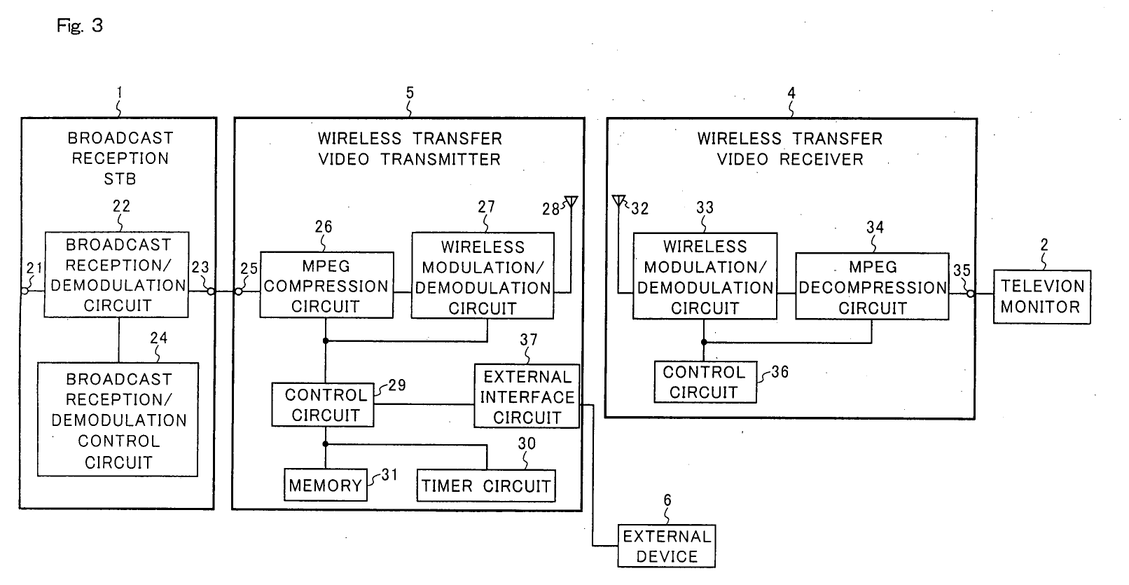

FIG. 3 shows the configuration of the wireless transfer system of a second embodiment of the present invention. In FIG. 3, such parts as are found also in FIG. 1 are identified with common reference numerals, and no detailed explanations thereof will be repeated.

In comparison with the wireless transfer system of the first embodiment of the invention, the wireless transfer system of the second embodiment of the invention includes, instead of the wireless transfer video transmitter 3 provided in the former, a wireless transfer video transmitter 5, and thus includes the wireless transfer video transmitter 5 and the wireless transfer video receiver 4. In comparison with the wireless transfer video transmitter 3, the wireless transfer video transmitter 5 is further provided with an external interface circuit 37.

The control circuit 29 reads the viewing start time and the viewing end time or the viewing duration stored in the memory 31, and delivers them to the external interface circuit 37. The external interface circuit 37 then sends information relating to the viewing start time and the viewing end time or the viewing duration to an external device (for example, a personal computer, portable data terminal, or cellular phone) 6. The external device 6 then sends the information relating to the viewing start time and the viewing end time or the viewing duration to a fee biller (unillustrated) at a broadcast company. Based on the thus received information relating to the viewing start time and the viewing end time or the viewing duration, the fee biller calculates the amount of money to be billed.

In the configuration shown in FIG. 3, the external interface circuit 37 and the external device 6 are connected together on a wired basis. This, however, does not necessarily have to be so. Alternatively, for example, the external interface circuit 37 may be built as an IrDA infrared communication interface circuit including an infrared light-emitting diode and an infrared light-receiving unit. In this case, the external device 6 may also be provided with an IrDA infrared communication interface circuit so that bi-directional communication is possible at a close distance (about 30 centimeters) between the external interface circuit 37 and the external device 6.

### Third Embodiment

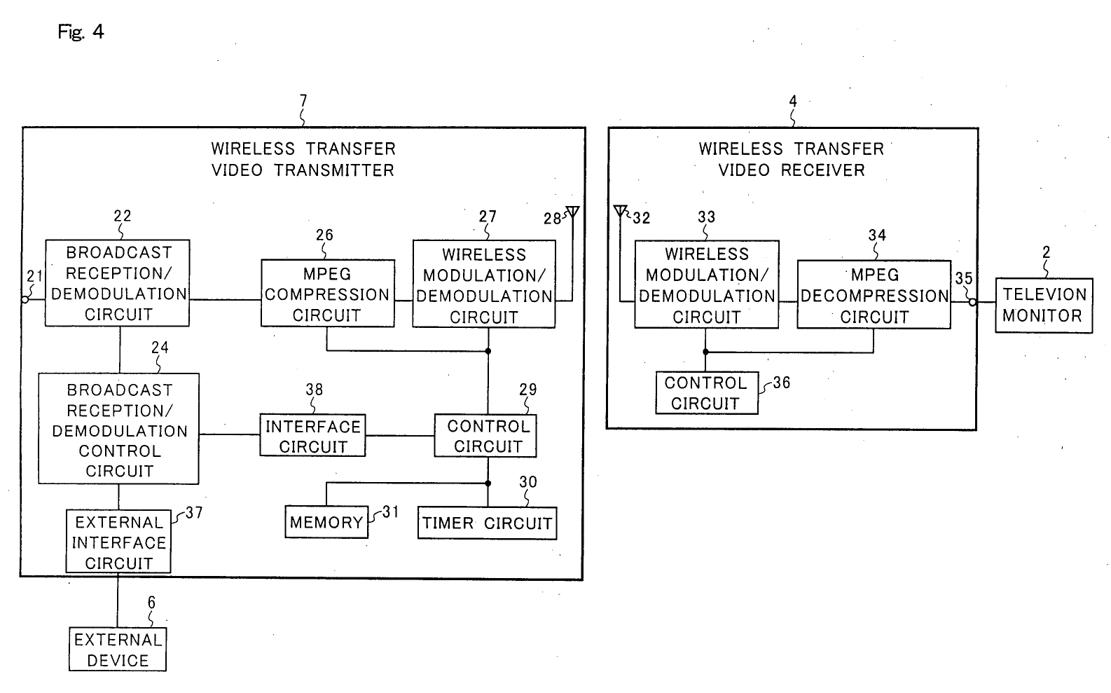

FIG. 4 shows the configuration of the wireless transfer system of a third embodiment of the present invention. In FIG. 4, such parts as are found also in FIG. 3 are identified with common reference numerals, and no detailed explanations thereof will be repeated.

In comparison with the wireless transfer system of the second embodiment of the invention, the wireless transfer system of the third embodiment of the invention includes, instead of the wireless transfer video transmitter 5 provided in the former, a wireless transfer video transmitter 7, and thus includes the wireless transfer video transmitter 7 and the wireless transfer video receiver 4. In comparison with the wireless transfer video transmitter 5, the wireless transfer video transmitter 7 lacks the input terminal 25, but is further provided with an input terminal 21, a broadcast reception/demodulation circuit 22, a broadcast reception/demodulation control circuit 24, and an interface circuit 38. That is, in the wireless transfer video transmitter 7, the functions of the broadcast reception STB 1 shown in FIG. 3 are incorporated in the wireless transfer video transmitter 5 so as to be housed in one housing.

The external interface circuit 37 is connected not to the control circuit 29 but to the broadcast reception/demodulation control circuit 24. Moreover, the broadcast reception/demodulation control circuit 24 and the control circuit 29 are connected together via the interface circuit 38 so that they can exchange data with each other. Thus, the control circuit 29 can read the viewing start time and the viewing end time or the viewing duration stored in the memory 31 and deliver them via the interface circuit 38 and the broadcast reception/demodulation control circuit 24 to the external interface circuit 37. The external interface circuit 37 then sends information relating to the viewing start time and the viewing end time or the viewing duration to a external device 6, and the external device 6 then sends the information relating to the viewing start time and the viewing end time or the viewing duration to a fee biller (unillustrated) at a broadcast company. Based on the thus received information relating to the viewing start time and the viewing end time or the viewing duration, the fee biller calculates the amount of money to be billed.

The broadcast reception/demodulation circuit 22 may extract information relating to the current time from the signals that the broadcast reception/demodulation circuit 22 itself has demodulated so that the extracted information is fed via the broadcast reception/demodulation control circuit 24, the interface circuit 38, and the control circuit 29 to the timer circuit 30 to permit the timer circuit 30 to adjust the current time based on the information relating to the current time from the broadcast reception/demodulation circuit 22.

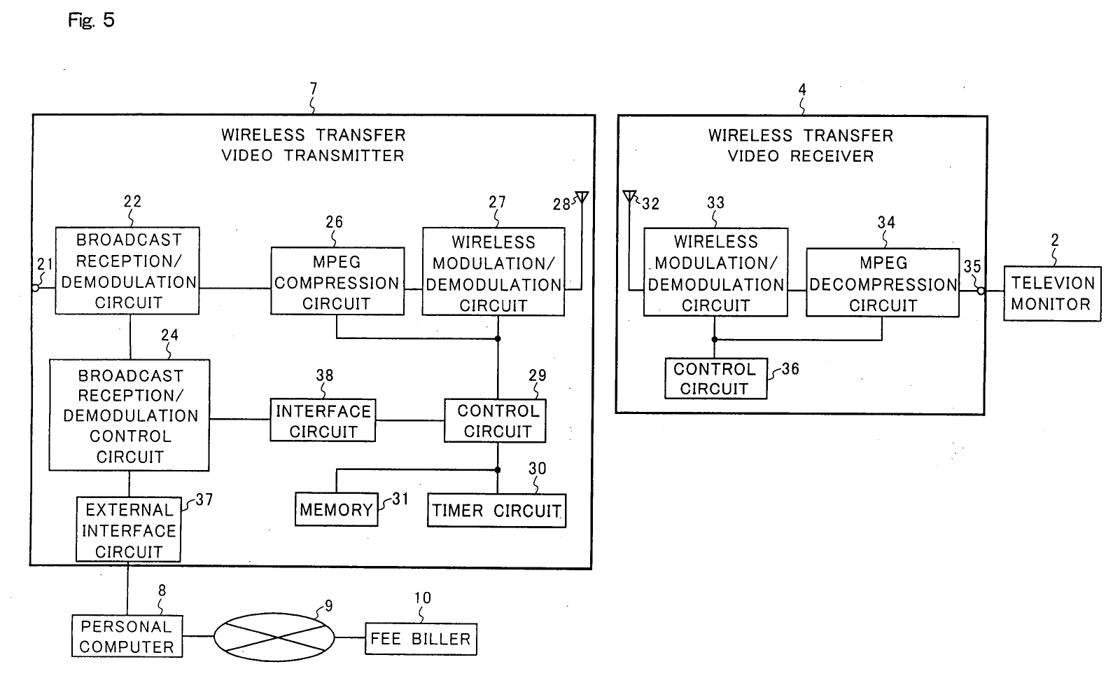

In the configuration shown in FIG. 4, and also in that shown in FIG. 5 described later, the external interface circuit 37 and the external device 6 (such as a personal computer 8) are connected together on a wired basis. This, however, does not necessarily have to be so. Alternatively, for example, the external interface circuit 37 may be built as an IrDA infrared communication interface circuit including an infrared light-emitting diode and an infrared light-receiving unit. In this case, the external device 6 (such as a personal computer 8) may also be provided with an IrDA infrared communication interface circuit so that bi-directional communication is possible at a close distance (about 30 centimeters) between the external interface circuit 37 and the external device 6 (such as a personal computer 8).

In a case where the external device 6 connected to the external interface circuit 37 provided in the wireless transfer video transmitter 7 in the wireless transfer system of the third embodiment of the invention is a personal computer 8, the configuration is as shown in FIG. 5. The personal computer 8 is connected over the Internet 9 to a fee biller 10 installed at a broadcast company.

For example, a viewer signs a contract with a broadcast company (a broadcast station or broadcast provider) to view chargeable broadcast programs. At the time of the contract, each viewer is assigned a unique contract number by which the viewer can be identified. Moreover, at the time of the contract, a software program for accessing the fee biller 10 of the broadcast company over the Internet 9 is, together with the contract number assigned to the viewer, installed on the personal computer 8. With these preparations done, when the viewer operates the personal computer 8 so that the personal computer 8 connects over the Internet 9 to the fee biller 10 of the broadcast company, the fee biller 10 can identify the viewer by the contract number, and can also acquire information relating to the viewing start time and the viewing end time or the viewing duration.

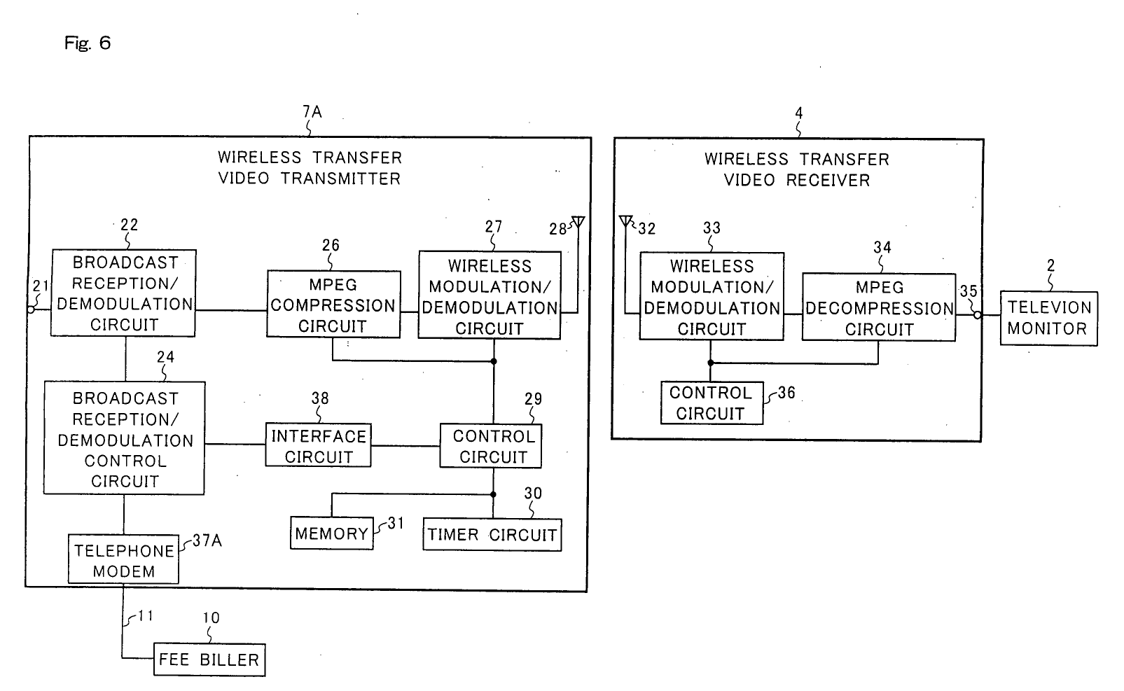

In FIGS. 6 to 9 referred to in the following description, such parts as are found also in FIG. 5 are identified with common reference numerals, and no detailed explanations thereof will be repeated.

The wireless transfer video transmitter 7 in the wireless transfer system of the third embodiment of the invention may be configured like the wireless transfer video transmitter 7A shown in FIG. 6. The wireless transfer video transmitter 7A shown in FIG. 6 adopts as an external interface circuit a telephone modem 37A that conducts data communication over a telephone network. The telephone modem 37A is connected, without intermediation of an external device, over a telephone network 11 to a fee biller 10 at a broadcast company. The telephone modem 37A transmits to the fee biller 10 information relating to the viewing start time and the viewing end time or the viewing duration and in addition information relating to the previously assigned unique contact number.

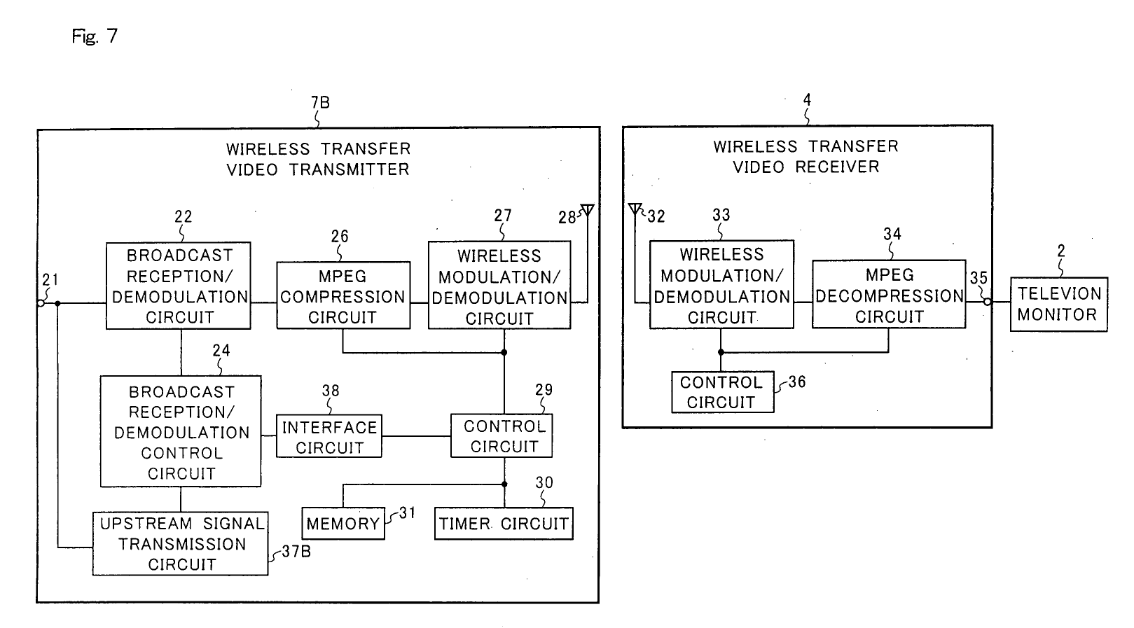

In a case where a CATV cable is connected to the input terminal 21 provided in the wireless transfer video transmitter 7 of the wireless transfer system of the third embodiment of the invention, the wireless transfer video transmitter 7 may be configured like the wireless transfer video transmitter 7B shown in FIG. 7. The wireless transfer video transmitter 7B shown in FIG. 7 adopts as an external interface circuit an upstream signal transmission circuit 37B. One way for the upstream signal transmission circuit 37B to produce an upstream signal is to produce it in a frequency band that is not used for broadcast signals. The upstream signal transmission circuit 37B is connected to the input terminal 21, and is connected, without intermediation of an external device, via the input terminal 21 and the CATV cable (unillustrated) to a fee biller (unillustrated) at a broadcast company. The upstream signal transmission circuit 37B transmits to the fee biller (unillustrated) information relating to the viewing start time and the viewing end time or the viewing duration and in addition information relating to the previously assigned unique contact number.

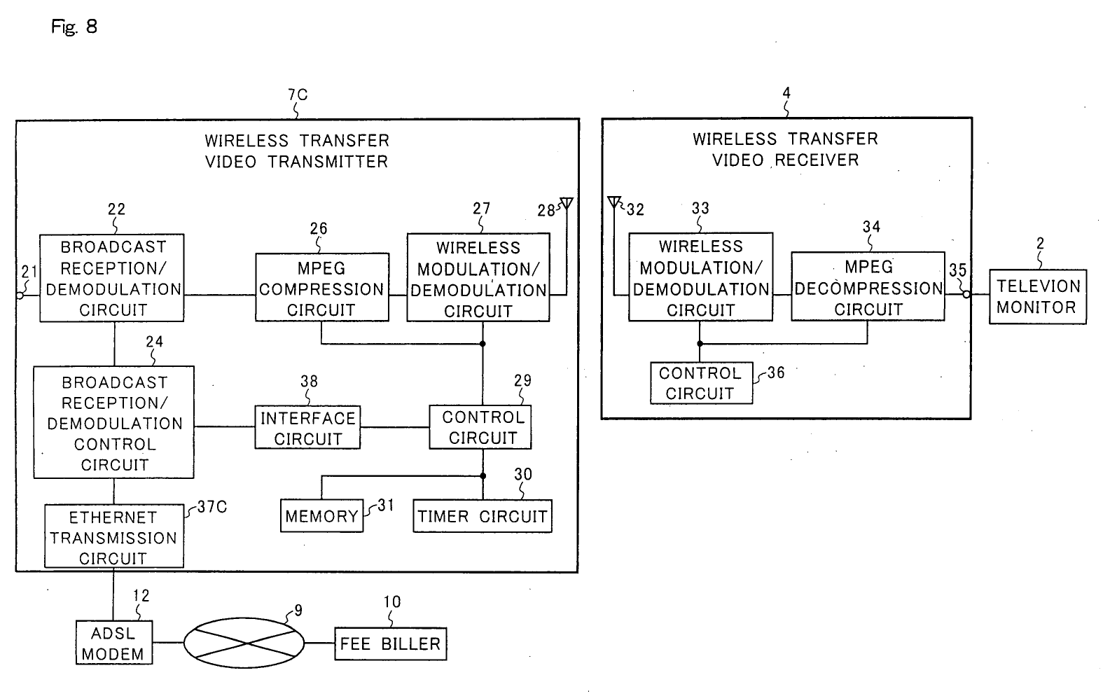

The wireless transfer video transmitter 7 of the wireless transfer system of the third embodiment of the invention may be configured like the wireless transfer video transmitter 7C shown in FIG. 8. The wireless transfer video transmitter 7C shown in FIG. 8 adopts as an external interface circuit an Ethernet transmission circuit 37C. The Ethernet transmission circuit 37C is connected via an ADSL modem 12, which is an external device, and over the Internet 9 to a fee biller 10 at a broadcast company. The Ethernet transmission circuit 37C transmits to the fee biller 10 information relating to the viewing start time and the viewing end time or the viewing duration and in addition information relating to the previously assigned unique contact number.

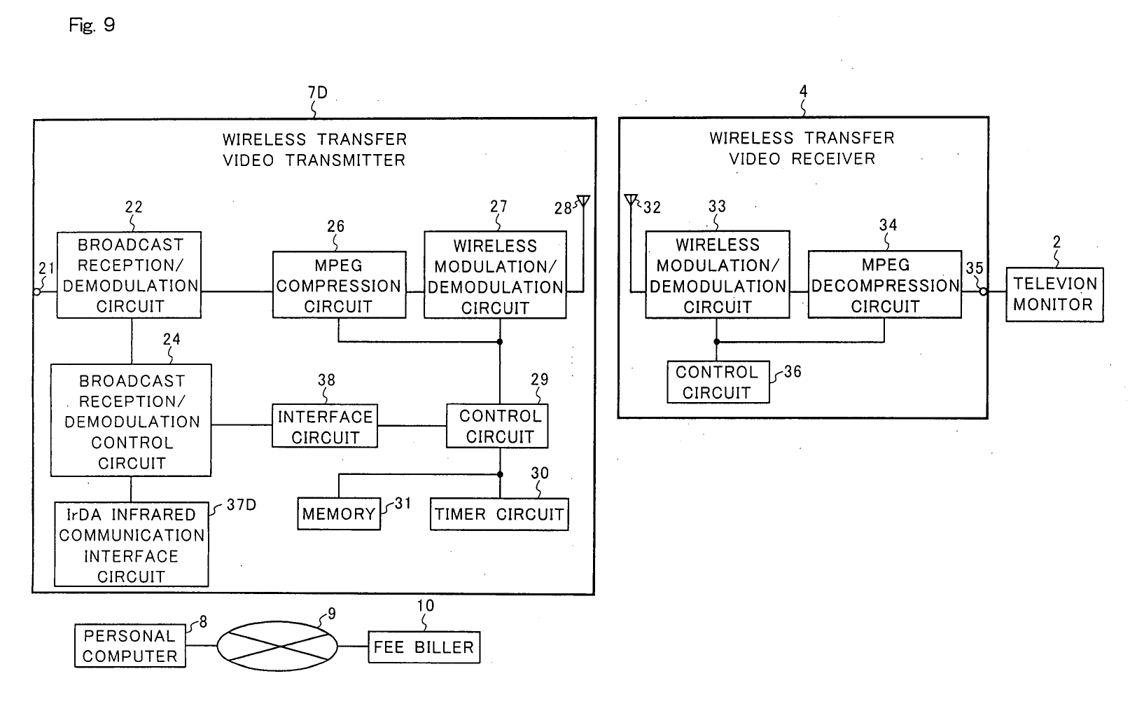

In a case where the external device that receives the information relating to the viewing start time and the viewing end time or the viewing duration from the wireless transfer video transmitter 7 is provided with an IrDA infrared communication interface circuit, the wireless transfer video transmitter 7 of the wireless transfer system of the third embodiment of the invention may be configured like the wireless transfer video transmitter 7D shown in FIG. 9. The wireless transfer video transmitter 7D shown in FIG. 9 adopts as an external interface circuit an IrDA infrared communication interface circuit 37D including an infrared light-emitting diode and an infrared light-receiving module. The IrDA infrared communication interface circuit 37D is connected via a personal computer 8, which is an external device, and over the Internet 9 to a fee biller 10 at a broadcast company.

The personal computer 8 provided with an IrDA infrared communication interface circuit may be replaced with a cellular phone or the like provided with an IrDA infrared communication interface circuit.

When a viewer signs a contract with a broadcast company to view chargeable broadcast programs, the viewer may access the WEB site of the broadcast company on the personal computer 8, cellular phone, or the like to download a software program for communication with the IrDA infrared communication interface circuit 37D and install it on the personal computer 8, cellular phone, or the like beforehand.

When a viewer signs a contract with a broadcast company to view chargeable broadcast programs, the viewer may access the WEB site of the broadcast company on the personal computer 8, cellular phone, or the like to register the viewer's mail address at the WEB site of the broadcast company. The purpose is as follows. On the settling day of each month, a mail message is sent from the WEB site of the broadcast company to the registered mail address. When the viewer opens the mail message on the personal computer 8, cellular phone, or the like, a software program for communication with the IrDA infrared communication interface circuit 37D is executed. As a result, the personal computer 8, cellular phone, or the like reads, from the wireless transfer video transmitter 7D via IrDA, information relating to all the viewing start times and the viewing end times or the viewing durations for the month, and then registers the information over the Internet 9 at the WEB site of the broadcast company. At this point, the amount to be billed is calculated. Then, for example, the calculated amount is sent from the WEB site of the broadcast company to the personal computer 8, cellular phone, or the like, and is displayed on the screen of the personal computer 8, cellular phone, or the like with a message like “you will be charged 2,000 yen this month”. When a cellular phone is used instead of the personal computer 8, the fee collection service of the cellular phone company may be used so that the viewer pays the amount of the sum of the above fees and the fees for the use of the cellular phone.

### Fourth Embodiment

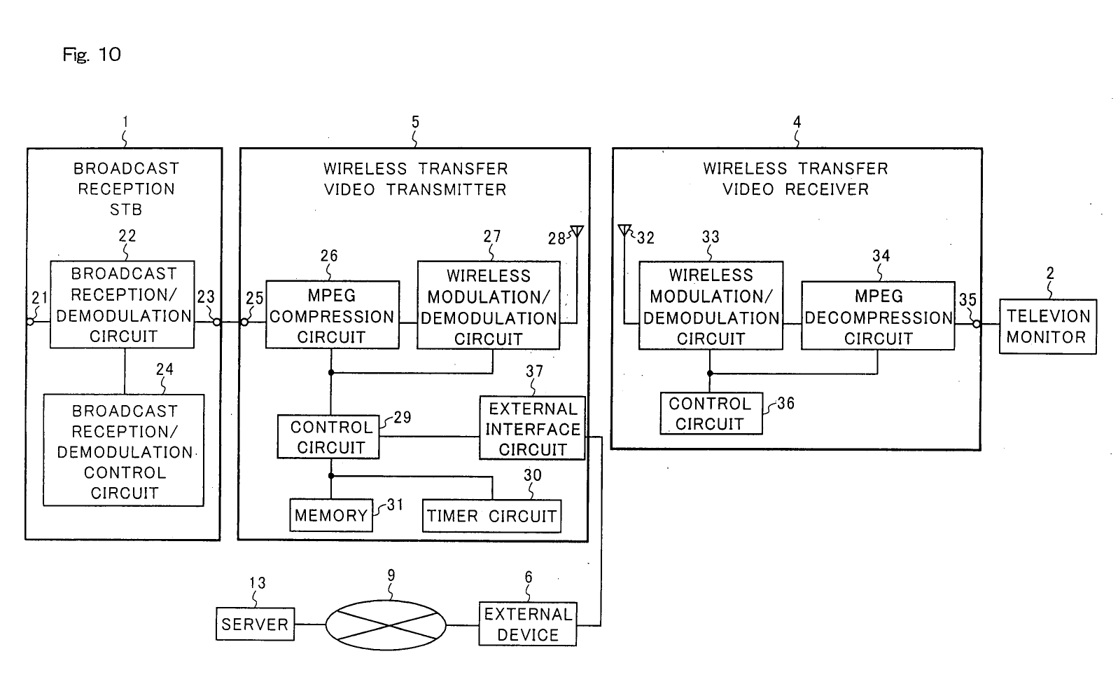

FIG. 10 shows the configuration of the wireless transfer system of a fourth embodiment of the present invention. In FIG. 10, such parts as are found also in FIGS. 3 and 5 are identified with common reference numerals, and no detailed explanations thereof will be repeated.

Like the wireless transfer system of the second embodiment of the invention, the wireless transfer system of the fourth embodiment of the invention includes a wireless transfer video transmitter 5 and a wireless transfer video receiver 4. Here, the control operation performed by the control circuit 29 is different from that performed in the wireless transfer system of the second embodiment of the invention.

A server 13 transmits information relating to a permitted viewing period over the Internet 9 to the external device 6, and the external device 6 transmits the received information relating to the permitted viewing period to the external interface circuit 37. The control circuit 29 performs control according to the information relating to the permitted viewing period received by the external interface circuit 37. The information relating to the permitted viewing period may be stored in the memory 31 under the control of the control circuit 29. In this case, the information relating to the permitted viewing period is stored in a region different from the one in which the information relating to the viewing start time and the viewing end time or the viewing duration is stored.

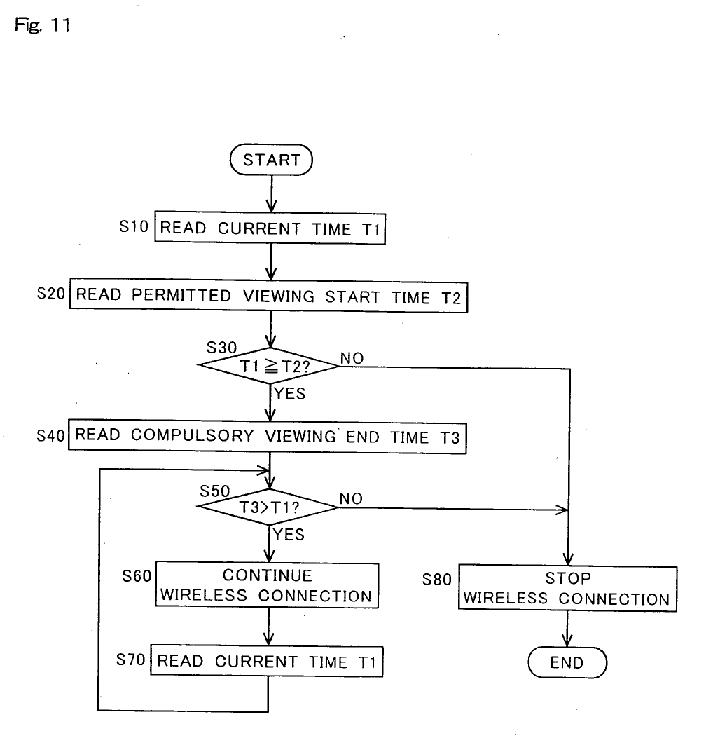

FIG. 11 shows the procedure performed to control wireless connection in a case where the information relating to the permitted viewing period consists of a permitted viewing start time and a compulsory viewing end time.

When the wireless transfer video transmitter 5 is started up, the control circuit 29 immediately tries to connect to the wireless transfer video receiver 4, and, at this point, reads the current time T1 from the timer circuit 30 (step S10). The control circuit 29 then reads, from the external interface circuit 37 or the memory 31, the permitted viewing start time T2 included in the information relating to the permitted viewing period received by the external interface circuit 37 (step S20).

Then, the control circuit 29 checks whether or not the current time T1 is later than or equal to the permitted viewing start time T2 (step S30). If the current time T1 is not later than or equal to the permitted viewing start time T2, (“NO” in step S30), wireless connection is stopped (step S80), and the procedure ends. By contrast, if the current time T1 is later than or equal to the permitted viewing start time T2, (“YES” in step S30), the control circuit 29 reads, from the external interface circuit 37 or the memory 31, the compulsory viewing end time T3 included in the information relating to the permitted viewing period received by the external interface circuit 37 (step S40).

Then, the control circuit 29 checks whether or not the current time T1 is earlier than the compulsory viewing end time T3 (step S50). If the current time T1 is not earlier than the compulsory viewing end time T3 (“NO” in step S50), wireless connection is stopped (step S80), and the procedure ends. By contrast, if the current time T1 is earlier than the compulsory viewing end time T3 (“YES” in step S50), the control circuit 29 continues wireless connection (step S60), and reads the current time T1 again from the timer circuit 30 (step S70). The procedure then returns to step S50.

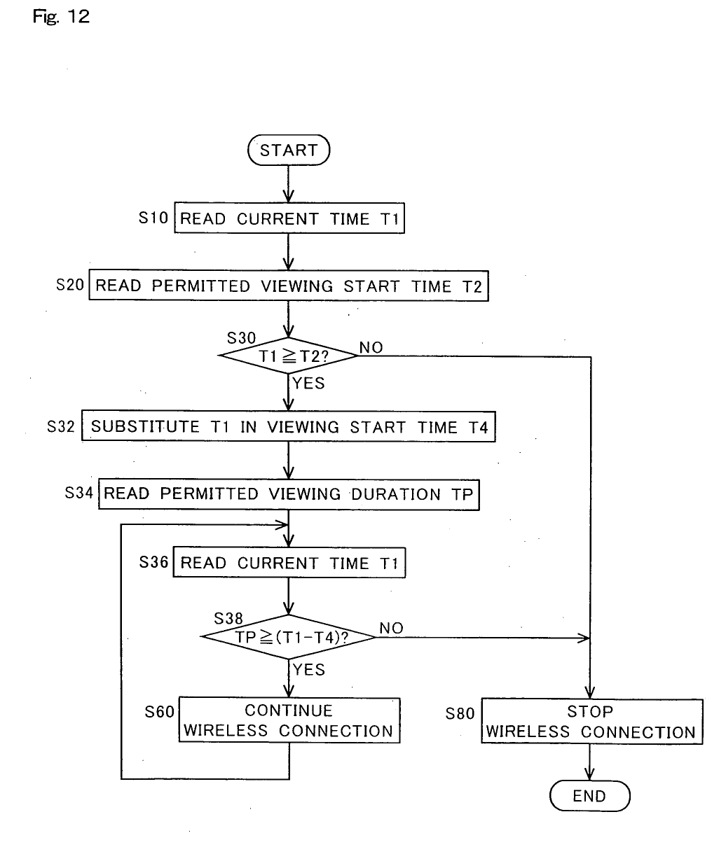

FIG. 12 shows the procedure performed to control wireless connection in a case where the information relating to the permitted viewing period consists of a permitted viewing start time and a permitted viewing duration. In FIG. 12, such steps as are found also in FIG. 11 are identified with common reference numerals.

When the wireless transfer video transmitter 5 is started up, the control circuit 29 immediately tries to connect to the wireless transfer video receiver 4, and, at this point, reads the current time T1 from the timer circuit 30 (step S10). The control circuit 29 then reads, from the external interface circuit 37 or the memory 31, the permitted viewing start time T2 included in the information relating to the permitted viewing period received by the external interface circuit 37 (step S20).

Then, the control circuit 29 checks whether or not the current time T1 is later than or equal to the permitted viewing start time T2 (step S30). If the current time T1 is not later than or equal to the permitted viewing start time T2, (“NO” in step S30), wireless connection is stopped (step S80), and the procedure ends. By contrast, if the current time T1 is later than or equal to the permitted viewing start time T2, (“YES” in step S30), the control circuit 29 stores, as a viewing start time T4 in the memory 31, the value of the current time T1 read in step S10 (step S32).

After step S32, the control circuit 29 reads, from the external interface circuit 37 or the memory 31, the permitted viewing duration TP included in the information relating to the permitted viewing period received by the external interface circuit 37 (step S34), and then reads the current time T1 again from the timer circuit 30 (step S36).

Then, the control circuit 29 checks whether or not the length of time from the viewing start time T4 to the current time T1 is shorter than or equal to the permitted viewing duration TP (step S38). If the length of time from the viewing start time T4 to the current time T1 is not shorter than or equal to the permitted viewing duration TP (“NO” in step S38), wireless connection is stopped (step S80), and the procedure ends. If the length of time from the viewing start time T4 to the current time T1 is shorter than or equal to the permitted viewing duration TP (“YES” in step S38), the control circuit 29 continues wireless connection (step S60). The procedure then returns to step S36.

Through one of the two control procedures described above, it is possible to control the viewing of chargeable broadcast programs.

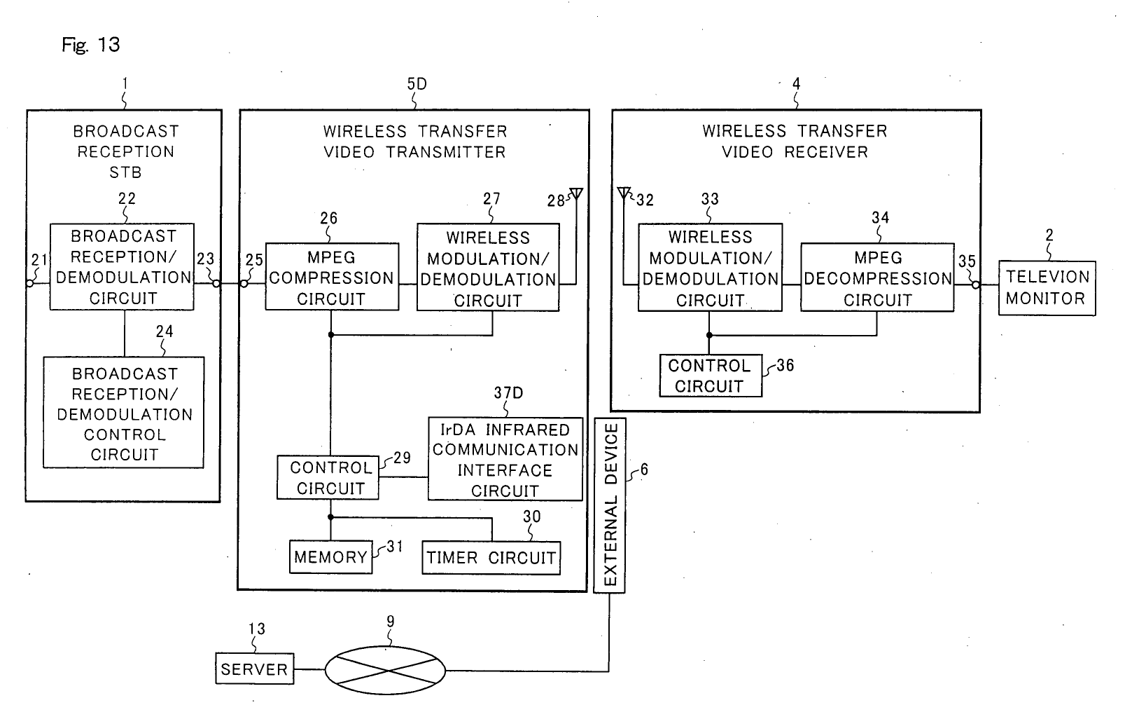

In a case where the external device that sends the information relating to the permitted viewing period to the wireless transfer video transmitter 5 is provided with an IrDA infrared communication interface circuit, the wireless transfer video transmitter 5 in the wireless transfer system of the fourth embodiment of the invention may be configured like the wireless transfer video transmitter 5D shown in FIG. 13. The wireless transfer video transmitter 5D shown in FIG. 13 adopts as an external interface circuit an IrDA infrared communication interface circuit 37D including an infrared light-emitting diode and an infrared light-receiving module. The IrDA infrared communication interface circuit 37D is connected via the external device 6 and over the Internet 9 to a server 13 at a broadcast company. The external device 6 provided with an IrDA infrared communication interface circuit is, for example, a personal computer or a cellular phone. In this case, when a viewer signs a contract with a broadcast company to view chargeable broadcast programs, the viewer may access the WEB site of the broadcast company on the external device 6, such as a personal computer or cellular phone, to register the viewer's mail address at the WEB site of the broadcast company. The purpose is as follows. On the settling day of each month, a mail message is sent from the WEB site of the broadcast company to the registered mail address. When the viewer opens the mail message on the external device 6, such as a personal computer or cellular phone, a software program for communication with the IrDA infrared communication interface circuit 37D is executed. The viewer then operates the external device 6, such as a personal computer or cellular phone, to separately make a prepayment of fees and thereby acquire information relating to a permitted viewing period. The fee collection service or the like of a cellular phone company may be used so that the viewer pays the amount of the sum of the above prepaid fees and the fees for the use of a cellular phone.

### Fifth Embodiment

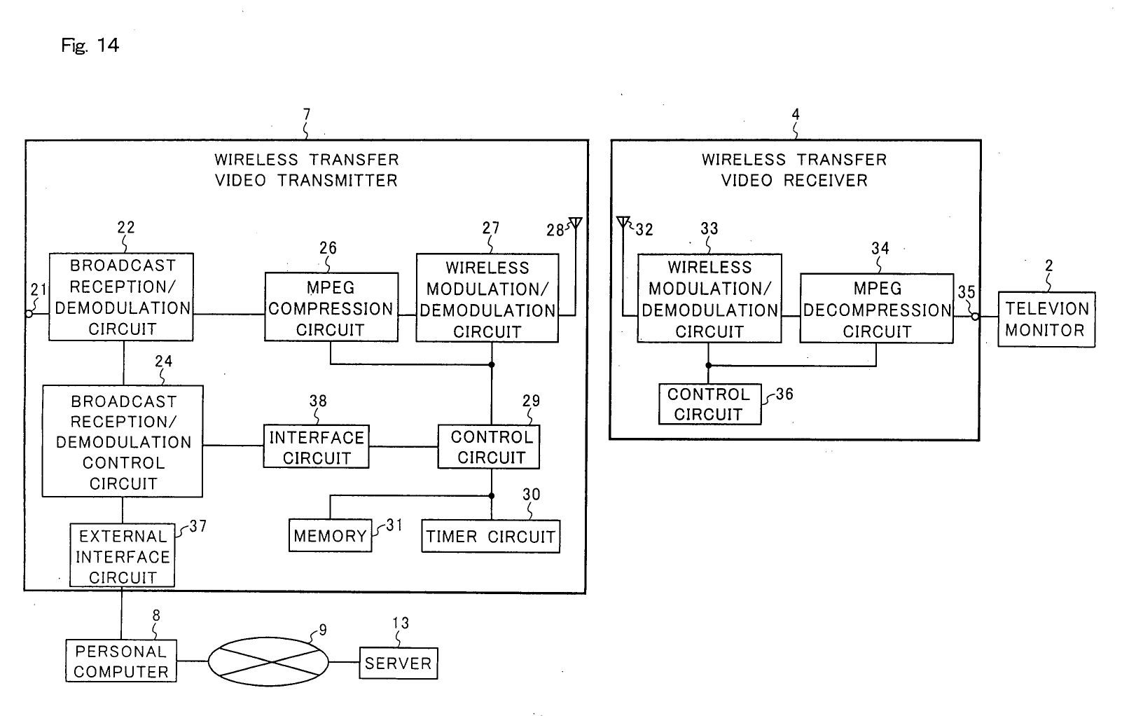

FIG. 14 shows the configuration of the wireless transfer system of a fifth embodiment of the present invention. The wireless transfer system of the fifth embodiment of the invention has the same configuration as the wireless transfer system of the third embodiment shown in FIG. 5, except that the broadcast reception/demodulation control circuit 24 and the control circuit 29 here perform control operation differently than in the third embodiment.

A server 13 transmits information relating to a permitted viewing period over the Internet 9 to the personal computer 8, and the personal computer 8 transmits the received information relating to the permitted viewing period to the external interface circuit 37. The broadcast reception/demodulation control circuit 24 and the control circuit 29 perform control according to the information relating to the permitted viewing period received by the external interface circuit 37. The information relating to the permitted viewing period may be stored in the memory 31 under the control of the control circuit 29. In this case, the information relating to the permitted viewing period is stored in a region different from the one in which the information relating to the viewing start time and the viewing end time or the viewing duration is stored.

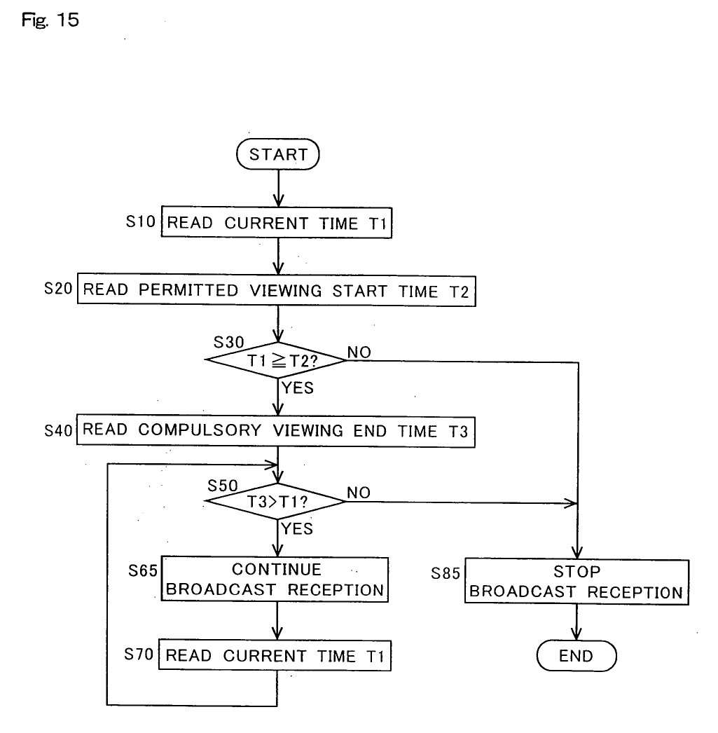

FIG. 15 shows the procedure performed to control wireless connection in a case where the information relating to the permitted viewing period consists of a permitted viewing start time and a compulsory viewing end time. In FIG. 15, such steps as are found also in FIG. 11 are identified with common reference numerals.

When the wireless transfer video transmitter 7 is started up, the control circuit 29 immediately tries to connect to the wireless transfer video receiver 4, and, at this point, reads the current time T1 from the timer circuit 30 (step S10). The control circuit 29 then reads, from the external interface circuit 37 or the memory 31, the permitted viewing start time T2 included in the information relating to the permitted viewing period received by the external interface circuit 37 (step S20).

Then, the control circuit 29 checks whether or not the current time T1 is later than or equal to the permitted viewing start time T2 (step S30). If the current time T1 is not later than or equal to the permitted viewing start time T2, (“NO” in step S30), the broadcast reception/demodulation control circuit 24 is made to stop broadcast reception (step S85), and the procedure ends. By contrast, if the current time T1 is later than or equal to the permitted viewing start time T2, (“YES” in step S30), the control circuit 29 reads, from the external interface circuit 37 or the memory 31, the compulsory viewing end time T3 included in the information relating to the permitted viewing period received by the external interface circuit 37 (step S40).

Then, the control circuit 29 checks whether or not the current time T1 is earlier than the compulsory viewing end time T3 (step S50). If the current time T1 is not earlier than the compulsory viewing end time T3 (“NO” in step S50), the broadcast reception/demodulation control circuit 24 is made to stop broadcast reception (step S85), and the procedure ends. By contrast, if the current time T1 is earlier than the compulsory viewing end time T3 (“YES” in step S50), the control circuit 29 makes the broadcast reception/demodulation control circuit 24 to continue broadcast reception (step S65), and reads the current time T1 again from the timer circuit 30 (step S70). The procedure then returns to step S50.

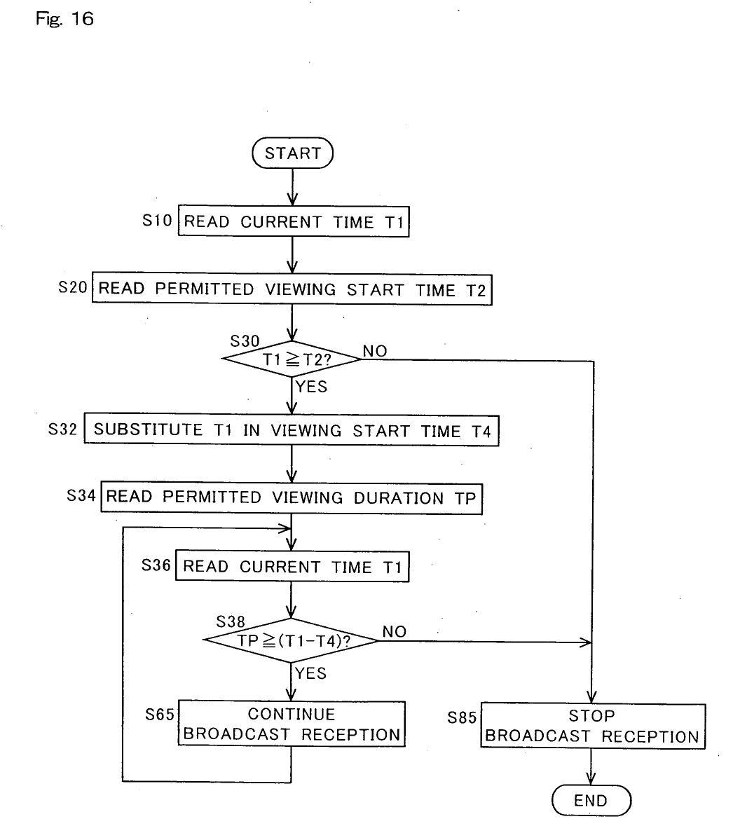

FIG. 16 shows the procedure performed to control wireless connection in a case where the information relating to the permitted viewing period consists of a permitted viewing start time and a permitted viewing duration. In FIG. 16, such steps as are found also in FIG. 15 are identified with common reference numerals.

When the wireless transfer video transmitter 7 is started up, the control circuit 29 immediately tries to connect to the wireless transfer video receiver 4, and, at this point, reads the current time T1 from the timer circuit 30 (step S10). The control circuit 29 then reads, from the external interface circuit 37 or the memory 31, the permitted viewing start time T2 included in the information relating to the permitted viewing period received by the external interface circuit 37 (step S20).

Then, the control circuit 29 checks whether or not the current time T1 is later than or equal to the permitted viewing start time T2 (step S30). If the current time T1 is not later than or equal to the permitted viewing start time T2, (“NO” in step S30), the broadcast reception/demodulation control circuit 24 is made to stop broadcast reception (step S85), and the procedure ends. By contrast, if the current time T1 is later than or equal to the permitted viewing start time T2, (“YES” in step S30), the control circuit 29 stores, as a viewing start time T4 in the memory 31, the value of the current time T1 read in step S11 (step S32).

After step S32, the control circuit 29 reads, from the external interface circuit 37 or the memory 31, the permitted viewing duration TP included in the information relating to the permitted viewing period received by the external interface circuit 37 (step S34), and then reads the current time T1 again from the timer circuit 30 (step S36).

Then, the control circuit 29 checks whether or not the length of time from the viewing start time T4 to the current time T1 is shorter than or equal to the permitted viewing duration TP (step S38). If the length of time from the viewing start time T4 to the current time T1 is not shorter than or equal to the permitted viewing duration TP (“NO” in step S38), the broadcast reception/demodulation control circuit 24 is made to stop broadcast reception (step S85), and the procedure ends. If the length of time from the viewing start time T4 to the current time T1 is shorter than or equal to the permitted viewing duration TP (“YES” in step S38), the control circuit 29 makes the broadcast reception/demodulation control circuit 24 to continue broadcast reception (step S65). The procedure then returns to step S36.

Through one of the two control procedures described above, it is possible to control the viewing of chargeable broadcast programs.

In a case where the personal computer 8 that sends the information relating to the permitted viewing period to the wireless transfer video transmitter 5 is provided with an IrDA infrared communication interface circuit, the external interface circuit provided in the wireless transfer video transmitter 7 of the wireless transfer system of the fifth embodiment of the invention may be built as an IrDA infrared communication interface circuit including an infrared light-emitting diode and an infrared light-receiving unit. Instead of the personal computer provided with an IrDA infrared communication interface circuit, a cellular phone, portable appliance, or the like may be used.

### Sixth Embodiment

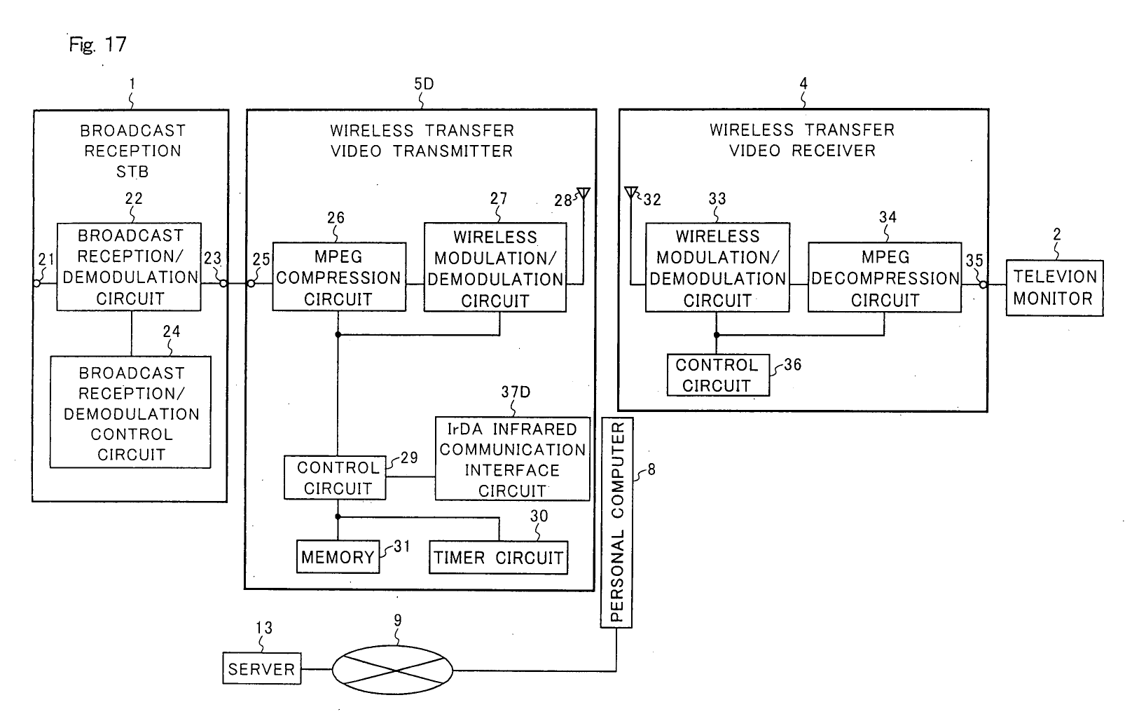

FIG. 17 shows the configuration of the wireless transfer system of a sixth embodiment of the present invention. The wireless transfer system of the sixth embodiment of the invention has the same configuration as the wireless transfer system of the fourth embodiment shown in FIG. 13, except that the control circuit 29 here performs control operation differently than in the third embodiment.

The personal computer 8 is provided with an IrDA infrared communication interface circuit. Moreover, when a viewer signs a contract with a broadcast company to view chargeable broadcast programs, a software program for conducting communication with the wireless transfer video transmitter 5D through IrDA infrared communication is installed on the personal computer 8. This software program runs on the personal computer 8, and serves to transmit, through IrDA infrared communication to the wireless transfer video transmitter 5D, electronic money data fed from a server 13 at the broadcast company over the Internet 9 to the personal computer 8 along with procedure data (hereinafter the “conversion-procedure data”) for converting the electronic money data into information relating to a permitted viewing period.

The control circuit 29 writes to an internal memory within the control circuit 29 or to the memory 31 the electronic money data and the conversion procedure data received by the IrDA infrared communication interface circuit 37D. Based on the conversion procedure data, the control circuit 29 converts the electronic money data into information relating to a permitted viewing period, and stores this information relating to the permitted viewing period to the internal memory within the control circuit 29 or to the memory 31.

The procedure for converting electronic money data into information relating to a permitted viewing period denotes a conversion formula by which, for example, “the value representing the amount of electric money is converted into a permitted viewing period”. In a simple example of operation, “an amount of electronic money equivalent to 100 yen permits viewing for one hour.” In this case, when a value equivalent to 5,000 yen?s worth of electronic money is read, viewing for 50 hours is permitted.

Depending on the type of contract and other factors, not all viewers can be uniformly “permitted one hour's viewing with 100 yen's worth of electronic money”. For example, some viewers may be “permitted two hours' viewing with 100 yen's worth of electronic money”. This is the reason that, as described above, every time electronic money data is sent from the personal computer 8 to the wireless transfer video transmitter 5D, conversion procedure data is sent together therewith from the personal computer 8 to the wireless transfer video transmitter 5D. This is preferable because doing so helps keep flexible correspondence between electronic money data and the viewing period permitted therewith.

In a more complex example of operation, varying fees can be billed in different periods during the day, for example, by “permitting one hour's viewing with 100 yen's worth of electronic money from 8 a.m. to 10 p.m. and with 50 yen's worth of electronic money otherwise”. Even in this case, as described above, every time electronic money data is sent from the personal computer 8 to the wireless transfer video transmitter 5D, conversion procedure data is sent together therewith from the personal computer 8 to the wireless transfer video transmitter 5D. Thus, when electronic money data is converted into a permitted viewing period, it can be done flexibly according to the current time checked by the timer circuit 30.

Incidentally, the value obtained through conversion of electronic money data can indicate a “permitted viewing period”, but cannot indicate a “permitted viewing start time”. Thus, either the value of a “permitted viewing start time” itself is sent from the personal computer 8 to the wireless transfer video transmitter 5D so as to be read by the control circuit 29, or the time at which the control circuit 29 reads the value of electronic money data is read from the timer circuit 30 so as to be read as a “permitted viewing start time” by the control circuit 29.

Through the operation described above, the control circuit 29 can recognize a “permitted viewing duration” and a “permitted viewing start time”. Moreover, the control circuit 29 can calculate a “compulsory viewing end time” from the “permitted viewing duration” and the “permitted viewing start time”. As in the fourth embodiment, the control circuit 29 performs the control operation shown in FIG. 11 when it uses the “permitted viewing start time” and the “compulsory viewing end time”, and performs the control operation shown in FIG. 12 when it uses the “permitted viewing start time” and the “permitted viewing duration”.

### Seventh Embodiment

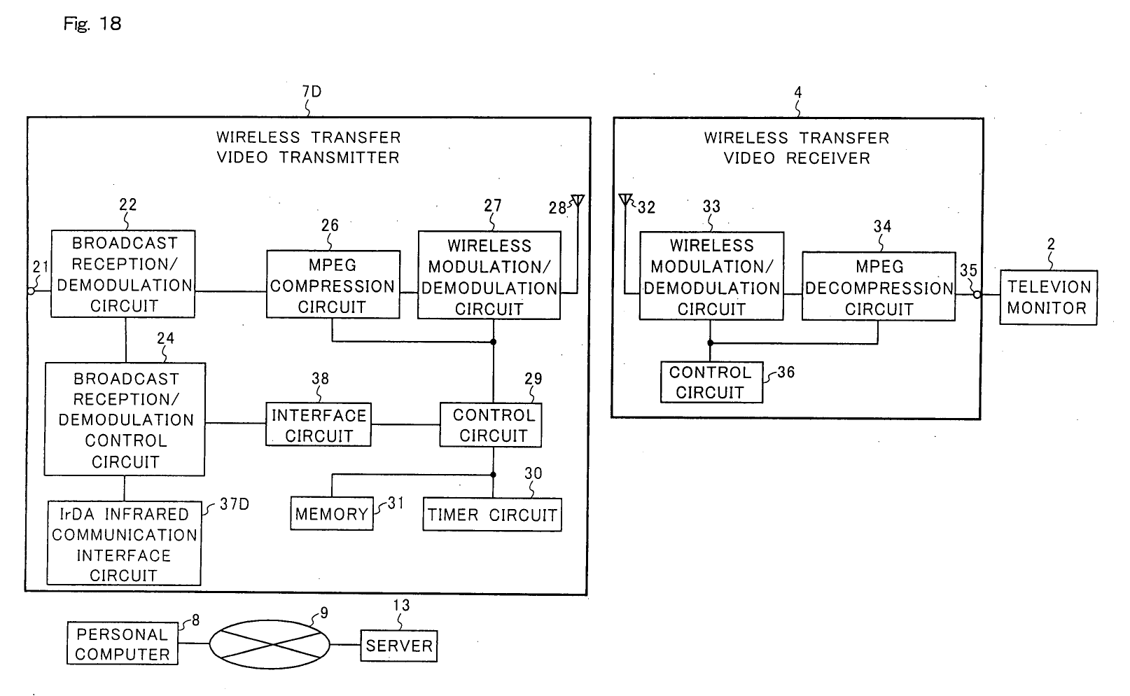

FIG. 18 shows the configuration of the wireless transfer system of a seventh embodiment of the present invention. The wireless transfer system of the seventh embodiment of the invention has the same configuration as the wireless transfer system of the third embodiment shown in FIG. 9, except that the broadcast reception/demodulation control circuit 24 and the control circuit 29 here perform control operation differently than in the third embodiment.

The personal computer 8 is provided with an IrDA infrared communication interface circuit. Moreover, when a viewer signs a contract with a broadcast company to view chargeable broadcast programs, a software program for conducting communication with the wireless transfer video transmitter 7D through IrDA infrared communication is installed on the personal computer 8. This software program runs on the personal computer 8, and serves to transmit, through IrDA infrared communication to the wireless transfer video transmitter 7D, electronic money data fed from a server 13 at the broadcast company over the Internet 9 to the personal computer 8 along with procedure data (hereinafter the “conversion procedure data”) for converting the electronic money data into information relating to a permitted viewing period.

The control circuit 29 writes to an internal memory within the control circuit 29 or to the memory 31 the electronic money data and the conversion procedure data received by the IrDA infrared communication interface circuit 37D. Based on the conversion procedure data, the control circuit 29 converts the electronic money data into information relating to a permitted viewing period, and stores this information relating to the permitted viewing period to the internal memory within the control circuit 29 or to the memory 31.

The procedure for converting electronic money data into information relating to a permitted viewing period denotes a conversion formula by which, for example, “the value representing the amount of electric money is converted into a permitted viewing period”. In a simple example of operation, “an amount of electronic money equivalent to 100 yen permits viewing for one hour.” In this case, when a value equivalent to 5,000 yen's worth of electronic money is read, viewing for 50 hours is permitted.

Depending on the type of contract and other factors, not all viewers can be uniformly “permitted one hour's viewing with 100 yen's worth of electronic money”. For example, some viewers may be “permitted two hours' viewing with 100 yen's worth of electronic money”. This is the reason that, as described above, every time electronic money data is sent from the personal computer 8 to the wireless transfer video transmitter 7D, conversion procedure data is sent together therewith from the personal computer 8 to the wireless transfer video transmitter 7D. This is preferable because doing so helps keep flexible correspondence between electronic money data and the viewing period permitted therewith.

In a more complex example of operation, varying fees can be billed in different periods during the day, for example, by “permitting one hour's viewing with 100 yen's worth of electronic money from 8 a.m. to 10 p.m. and with 50 yen's worth of electronic money otherwise”. Even in this case, as described above, every time electronic money data is sent from the personal computer 8 to the wireless transfer video transmitter 7D, conversion procedure data is sent together therewith from the personal computer 8 to the wireless transfer video transmitter 7D. Thus, when electronic money data is converted into a permitted viewing period, it can be done flexibly according to the current time checked by the timer circuit 30.

Incidentally, the value obtained through conversion of electronic money data can indicate a “permitted viewing period”, but cannot indicate a “permitted viewing start time”. Thus, either the value of a “permitted viewing start time” itself is sent from the personal computer 8 to the wireless transfer video transmitter 7D so as to be read by the control circuit 29, or the time at which the control circuit 29 reads the value of electronic money data is read from the timer circuit 30 so as to be read as a “permitted viewing start time” by the control circuit 29.

Through the operation described above, the control circuit 29 can recognize a “permitted viewing duration” and a “permitted viewing start time”. Moreover, the control circuit 29 can calculate a “compulsory viewing end time” from the “permitted viewing duration” and the “permitted viewing start time”. As in the fifth embodiment, the control circuit 29 performs the control operation shown in FIG. 15 when it uses the “permitted viewing start time” and the “compulsory viewing end time”, and performs the control operation shown in FIG. 16 when it uses the “permitted viewing start time” and the “permitted viewing duration”.

In the embodiments described above, the circuit blocks peculiar to the present invention, namely the timer circuit 30, the memory 31, and the external interface circuit 37 are provided on the part of the wireless transfer video transmitter. Alternatively, those circuit blocks may be provided on the part of the wireless transfer video receiver.

The input signals to a wireless transfer transmitter and the output signals from a wireless transfer receiver are not limited to video and audio signals, but may be, for example, a video signal or an audio signal alone.

In the embodiments described above, all the broadcast programs wirelessly transferred from the wireless transfer video transmitter to the wireless transfer video receiver are assumed to be chargeable broadcast programs. In a case where both chargeable and free-of-charge broadcast programs are available, for example, channel information may be incorporated in the signals fed to the wireless transfer video transmitter so that, according to the channel information, chargeable and free-of-charge broadcast programs are distinguished. This makes it possible, only for chargeable broadcast programs, to create information relating to the viewing start time and the viewing end time or the viewing duration, to bill fees, and to control viewing.

What is claimed is:

1. A wireless transfer system including
a wireless transfer transmitter that converts a source signal fed thereto into a radiowave and transmits the radiowave, and
a wireless transfer receiver that receives the radiowave transmitted from the wireless transfer transmitter and converts the radiowave back into the original source signal to produce an external output signal,
the wireless transfer system comprising
a time counting portion,
a storage portion, and
a control portion that creates, by using the time counting portion, information relating to a wireless connection duration between the wireless transfer transmitter and the wireless transfer receiver and stores the created information in the storage portion.

2. The wireless transfer system of claim 1, further comprising
a broadcast receiver that produces the source signal from a broadcast signal fed thereto and outputs the source signal to the wireless transfer transmitter,
wherein the broadcast receiver and the wireless transfer transmitter are housed in one housing.

3. The wireless transfer system of claim 1, further comprising
an external interface for delivering to an external device the information relating to the wireless connection duration between the wireless transfer transmitter and the wireless transfer receiver as stored in the storage portion.

4. The wireless transfer system of claim 2, further comprising
an external interface for delivering to an external device the information relating to the wireless connection duration between the wireless transfer transmitter and the wireless transfer receiver as stored in the storage portion.

5. A fee billing system comprising
a wireless transfer system, and
a fee biller,
wherein the wireless transfer system includes
a wireless transfer transmitter that converts a source signal fed thereto into a radiowave and transmits the radiowave, and
a wireless transfer receiver that receives the radiowave transmitted from the wireless transfer transmitter and converts the radiowave back into the original source signal to produce an external output signal,
wherein the wireless transfer system comprises
a time counting portion,
a storage portion,
a control portion that creates, by using the time counting portion, information relating to a wireless connection duration between the wireless transfer transmitter and the wireless transfer receiver and stores the created information in the storage portion,
and an external interface for delivering to an external device the information relating to the wireless connection duration between the wireless transfer transmitter and the wireless transfer receiver as stored in the storage portion, and
wherein the fee biller calculates an amount of money to be billed according to the information from the external interface provided in the wireless transfer system.

6. The fee billing system of claim 5,
wherein the wireless transfer system further comprises a broadcast receiver that produces the source signal from a broadcast signal fed thereto and outputs the source signal to the wireless transfer transmitter, and
wherein the broadcast receiver and the wireless transfer transmitter are housed in one housing.

7. A wireless transfer system including
a wireless transfer transmitter that converts a source signal fed thereto into a radiowave and transmits the radiowave, and
a wireless transfer receiver that receives the radiowave transmitted from the wireless transfer transmitter and converts the radiowave back into the original source signal to produce an external output signal,
the wireless transfer system comprising
a time counting portion,
an external interface for receiving information relating to a permitted viewing period from outside, and
a control portion that controls, by using the time counting portion and according to the information relating to the permitted viewing period, whether or not to permit wireless connection between the wireless transfer transmitter and the wireless transfer receiver.

8. A wireless transfer system including
a wireless transfer transmitter that converts a source signal fed thereto into a radiowave and transmits the radiowave, and
a wireless transfer receiver that receives the radiowave transmitted from the wireless transfer transmitter and converts the radiowave back into the original source signal to produce an external output signal,
the wireless transfer system comprising
a broadcast receiver that produces the source signal from a broadcast signal fed thereto and outputs the source signal to the wireless transfer transmitter,
a time counting portion,
an external interface for receiving information relating to a permitted viewing period from outside, and
a control portion that controls, by using the time counting portion and according to the information relating to the permitted viewing period, whether or not to permit the broadcast receiver to receive a broadcast,
wherein the broadcast receiver and the wireless transfer transmitter are housed in one housing.

9. A viewing control system comprising
a wireless transfer system, and
an information transmitter,
wherein the wireless transfer system includes
a wireless transfer transmitter that converts a source signal fed thereto into a radiowave and transmits the radiowave, and
a wireless transfer receiver that receives the radiowave transmitted from the wireless transfer transmitter and converts the radiowave back into the original source signal to produce an external output signal,
wherein the wireless transfer system comprises
a time counting portion,
an external interface for receiving information relating to a permitted viewing period from outside, and
a control portion that controls, by using the time counting portion and according to the information relating to the permitted viewing period, whether or not to permit wireless connection between the wireless transfer transmitter and the wireless transfer receiver, and
wherein the information transmitter sends the information relating to the permitted viewing period to the external interface provided in the wireless transfer system.

10. A viewing control system comprising
a wireless transfer system, and
an information transmitter,
wherein the wireless transfer system includes
a wireless transfer transmitter that converts a source signal fed thereto into a radiowave and transmits the radiowave, and
a wireless transfer receiver that receives the radiowave transmitted from the wireless transfer transmitter and converts the radiowave back into the original source signal to produce an external output signal,.
wherein the wireless transfer system comprises
a broadcast receiver that produces the source signal from a broadcast signal fed thereto and outputs the source signal to the wireless transfer transmitter,
a time counting portion,
an external interface for receiving information relating to a permitted viewing period from outside, and
a control portion that controls, by using the time counting portion and according to the information relating to the permitted viewing period, whether or not to permit the broadcast receiver to receive a broadcast,
wherein the broadcast receiver and the wireless transfer transmitter are housed in one housing, and
wherein the information transmitter sends the information relating to the permitted viewing period to the external interface provided in the wireless transfer system.

11. A wireless transfer system including
a wireless transfer transmitter that converts a source signal fed thereto into a radiowave and transmits the radiowave, and
a wireless transfer receiver that receives the radiowave transmitted from the wireless transfer transmitter and converts the radiowave back into the original source signal to produce an external output signal,
the wireless transfer system comprising
a time counting portion,
an external interface for receiving electronic money data from outside, and
a control portion that converts the electronic money data into information relating to a permitted viewing period and controls, by using the time counting portion and according to the information relating to the permitted viewing period, whether or not to permit wireless connection between the wireless transfer transmitter and the wireless transfer receiver.

12. A wireless transfer system including
a wireless transfer transmitter that converts a source signal fed thereto into a radiowave and transmits the radiowave, and
a wireless transfer receiver that receives the radiowave transmitted from the wireless transfer transmitter and converts the radiowave back into the original source signal to produce an external output signal,
the wireless transfer system comprising
a broadcast receiver that produces the source signal from a broadcast signal fed thereto and outputs the source signal to the wireless transfer transmitter,
a time counting portion,
an external interface for receiving electronic money data from outside, and
a control portion that converts the electronic money data into information relating to a permitted viewing period and controls, by using the time counting portion and according to the information relating to the permitted viewing period, whether or not to permit the broadcast receiver to receive a broadcast,
wherein the broadcast receiver and the wireless transfer transmitter are housed in one housing.

13. A viewing control system comprising
a wireless transfer system, and
an information transmitter,
wherein the wireless transfer system includes
a wireless transfer transmitter that converts a source signal fed thereto into a radiowave and transmits the radiowave, and
a wireless transfer receiver that receives the radiowave transmitted from the wireless transfer transmitter and converts the radiowave back into the original source signal to produce an external output signal,
wherein the wireless transfer system comprises
a time counting portion,
an external interface for receiving electronic money data from outside, and
a control portion that converts the electronic money data into information relating to a permitted viewing period and controls, by using the time counting portion and according to the information relating to the permitted viewing period, whether or not to permit wireless connection between the wireless transfer transmitter and the wireless transfer receiver, and
wherein the information transmitter sends the electronic money data to the external interface provided in the wireless transfer system.

14. A viewing control system comprising
a wireless transfer system, and
an information transmitter,
wherein the wireless transfer system includes
a wireless transfer transmitter that converts a source signal fed thereto into a radiowave and transmits the radiowave, and
a wireless transfer receiver that receives the radiowave transmitted from the wireless transfer transmitter and converts the radiowave back into the original source signal to produce an external output signal,
wherein the wireless transfer system comprises
a broadcast receiver that produces the source signal from a broadcast signal fed thereto and outputs the source signal to the wireless transfer transmitter,
a time counting portion,
an external interface for receiving electronic money data from outside, and
a control portion that converts the electronic money data into information relating to a permitted viewing period and controls, by using the time counting portion and according to the information relating to the permitted viewing period, whether or not to permit the broadcast receiver to receive a broadcast,
wherein the broadcast receiver and the wireless transfer transmitter are housed in one housing, and
wherein the information transmitter sends the electronic money data to the external interface provided in the wireless transfer system.
